(19) United States
(12) Patent Application Publication
(10) Pub. No.: US 2010/0072023 A1
(43) Pub. Date: Mar. 25, 2010

(54) Bill-Receiving Apparatus

(76) Inventor: John Pai, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/233,699

(22) Filed: Sep. 19, 2008

(51) Int. Cl. G07D 7/00

(52) U.S. Cl. 194/207

(57) ABSTRACT

A bill-receiving apparatus includes a shell, a front cover, a bill-feeding mechanism and a sensor assembly. The front cover is attached to a front side of the shell. The front cover includes a slot through which a bill can be inserted into the shell. The bill-feeding mechanism can feed the bill. The bill-feeding mechanism includes two pulley-belt modules each mounted on a side of the shell. The sensor assembly includes an upper sensor box and a lower sensor box. Each of the upper and lower sensor boxes includes a control board, a protective element and a body. At least one sensor is mounted on the control board. The protective element includes at least one bubble enclosing the at least one sensor. The body includes at least one window in which the at least one bubble is disposed.

### BACKGROUND OF THE INVENTION

The present invention relates to a bill-receiving apparatus for an automatic teller machine or vending machine.

Automatic teller machines and vending machines are used to provide service to customers 24 hours a day. An automatic teller machine or vending machine is equipped with a coin-receiving apparatus and a bill-receiving apparatus. A user can toss coins into the coin-receiving apparatus or insert bills into the bill-receiving apparatus. The amount of the payment will be counted. Goods will be provided or a transaction will be made according to the amount of the payment.

Referring to FIG. 8, a conventional bill-receiving apparatus includes a shell 4, a front cover 411, two lateral covers, a bill-feeding mechanism, a cassette 41, a first sensor assembly 40 and a second sensor assembly 45. The front cover 411 includes a slot defined therein. The front cover 411 is secured to a front side of the shell 4. The bill-feeding mechanism includes a motor and two pulley-belt modules operatively connected to the motor. Each of the pulley-belt modules is mounted on a related one of the lateral covers. The lateral covers are detachably attached to lateral sides of the shell 4. The cassette 41 is detachably attached to a rear side of the shell 4, behind the bill-feeding mechanism. The first sensor assembly 40 includes an upper sensor box 42 and a lower sensor box 44. As a bill is inserted into the bill-receiving apparatus through the slot, the first sensor assembly 40 detects the bill and actuates the bill-feeding mechanism to feed the bill into the cassette 41.

Referring to FIG. 9, the upper sensor box 42 includes an L-shaped body 421, two locking units, sheaths 432, a control board 43, two feeding units and a cover 424. The body 421 includes windows 422 defined therein and pegs 423 formed thereon. Each of the locking units includes an elastic leaf 433 and a latch 434 transversely extended from the elastic leaf 433. The elastic leaves 433 are inserted in the body 421 while the latches 434 are inserted through two apertures defined in the body 421. Each of the feeding units includes a leaf spring 425 for supporting three rollers 426. Each of the rollers 426 includes a large portion disposed in the body 421 and a small portion extended from the body 421 through apertures defined in the body 421. Each of the sheaths 432 includes two open ends. The sheaths 432 are inserted through the windows 422. Sensors 431 are connected to the control board 43. The sensors 431 are inserted in the sheaths 432. Screws are driven into the pegs 423 through the control board 43 to secure the control board 43 to the body 421. Screws are driven into the body 421 through the cover 424 to secure the cover 424 to the body 421.

Referring to FIG. 10, the lower sensor box 44 includes a body 441, sheaths 444, a control board 445 and a cover 447. The body 441 includes windows 442 defined therein and pegs 443 formed on a lower side. Each of the sheaths 444 includes two open ends. The sheaths 444 are inserted through the windows 442. Sensors 446 are provided on the control board 445. The sensors 446 are inserted in the sheaths 444. Screws are driven into the pegs 443 through the control board 445 to secure the control board 445 to the body 441. Screws are driven into the body 441 through the cover 447 to secure the cover 447 to the body 441.

As described above, the sensors 431 and 446 are fit in the sheaths 432 and 444 while the sheaths 432 and 444 are fit in the windows 422 and 442 so that the control boards 43 and 445 are protected from vapor. It however requires precise assembly. There would otherwise be gaps between these elements, and vapor would penetrate the gaps and damage the control boards 43 and 445.

Therefore, the present invention is intended to obviate or at least alleviate the problems encountered in prior art.

### SUMMARY OF INVENTION

It is the primary objective of the present invention to provide a bill-receiving apparatus with a waterproof sensor assembly.

To achieve the foregoing objective, the waterproof bill-receiving apparatus includes a shell, a front cover, a bill-feeding mechanism and a sensor assembly. The front cover is attached to a front side of the shell. The front cover includes a slot through which a bill can be inserted. The bill-feeding mechanism can feed the bill. The bill-feeding mechanism includes two pulley-belt modules each mounted on a side of the shell. The sensor assembly includes an upper sensor box and a lower sensor box. Each of the upper and lower sensor boxes includes a control board, a protector element and a body. At least one sensor is mounted on the control board. The protective element includes at least one bubble for enclosing the sensor. The body includes at least one aperture through which the bubble is inserted.

Other objectives, advantages and features of the present invention will be apparent from the following description referring to the attached drawings.

### BRIEF DESCRIPTION OF DRAWINGS

The present invention will be described via the detailed illustration of the preferred embodiment referring to the drawings.

FIG. 1 is an exploded view of a bill-receiving apparatus equipped with a waterproof sensor assembly according to the preferred embodiment of the present invention.

FIG. 2 is a side view of the bill-receiving apparatus shown in FIG. 1.

FIG. 3 is an exploded view of an upper sensor box of the waterproof sensor assembly shown in FIG. 1.

FIG. 4 is an enlarged cutaway view of a protective element of the upper sensor box shown in FIG. 3.

FIG. 5 is an exploded view of a lower sensor box of the waterproof sensor assembly shown in FIG. 1.

FIG. 6 is an enlarged cutaway view of a protective element of the lower sensor box shown in FIG. 5.

FIG. 7 is a cross-sectional view of the waterproof sensor assembly shown in FIG. 1.

FIG. 8 is a cross-sectional view of a bill-receiving apparatus equipped with a conventional sensor assembly.

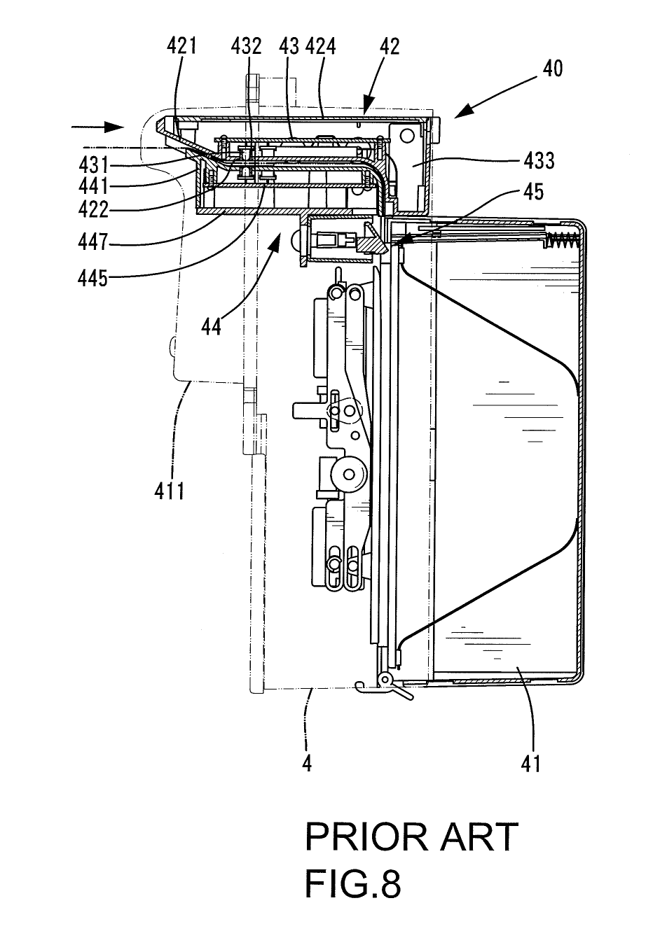

FIG. 9 is an exploded view of an upper sensor box of the conventional sensor assembly shown in FIG. 8.

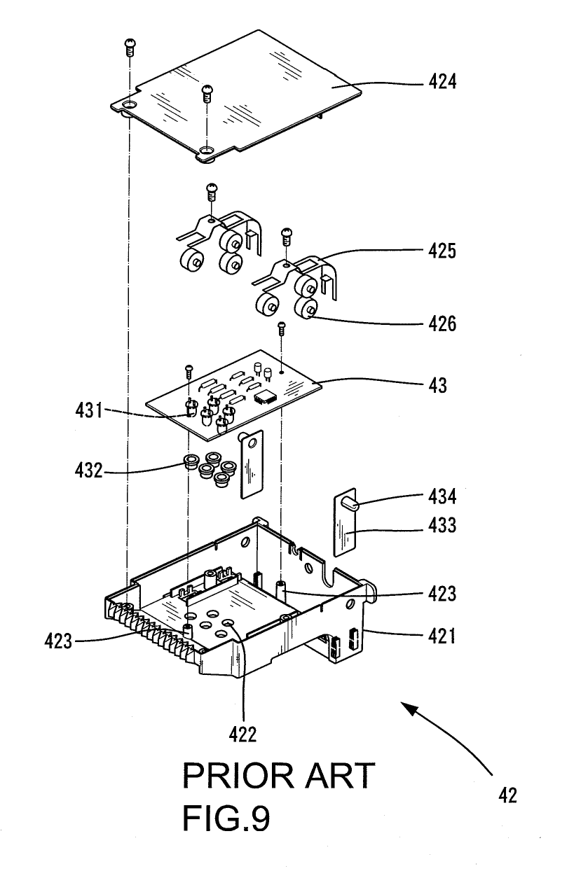

FIG. 10 is an exploded view of a lower sensor box of the conventional sensor assembly shown in FIG. 8.

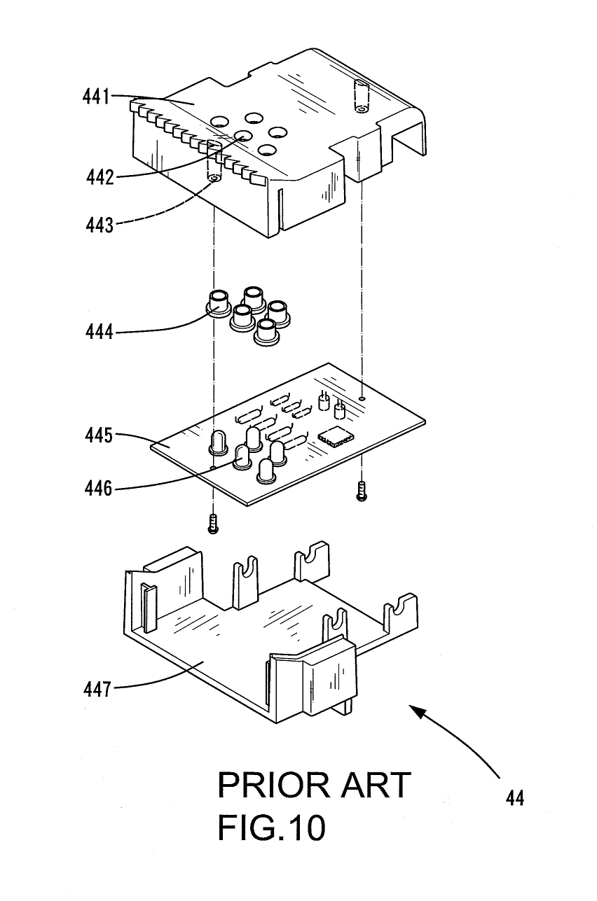

### DETAILED DESCRIPTION OF PREFERRED EMBODIMENT

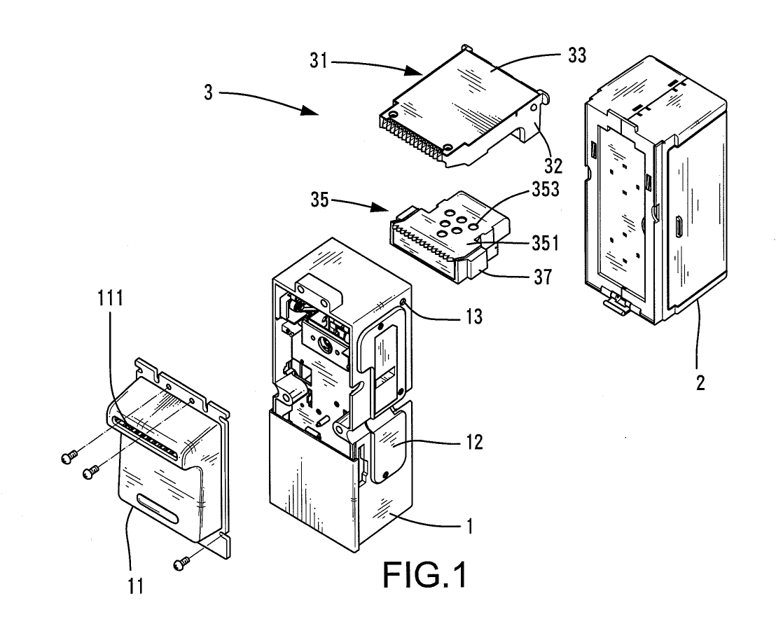

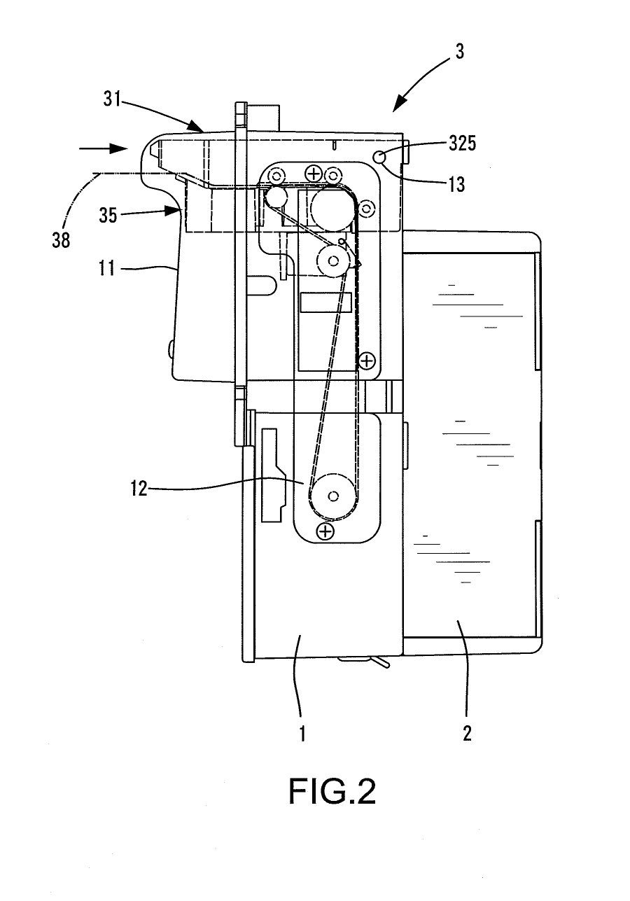

Referring to FIGS. 1 and 2, a bill-receiving apparatus includes a shell 1, a front cover 11, two lateral covers, a bill-feeding mechanism, a cassette 2 and a sensor assembly 3 according to the preferred embodiment of the present invention. The front cover 11 includes a slot 111 defined therein. The front cover 11 is secured to a front side of the shell 1. The bill-feeding mechanism includes two pulley-belt modules 12 operatively connected to a motor. Each of the pulley-belt modules 12 is mounted on a related one of the lateral covers. The lateral covers are detachably attached to lateral sides of the shell 4. The cassette 2 is detachably attached to a rear side of the shell 1, behind the bill-feeding mechanism. The sensor assembly 3 includes an upper sensor box 31 and a lower sensor box 35. As a bill 38 is inserted into the bill-receiving apparatus through the slot 111, the sensor assembly 3 detects the bill 38 and actuates the bill-feeding mechanism to feed the bill 38 into the cassette 2.

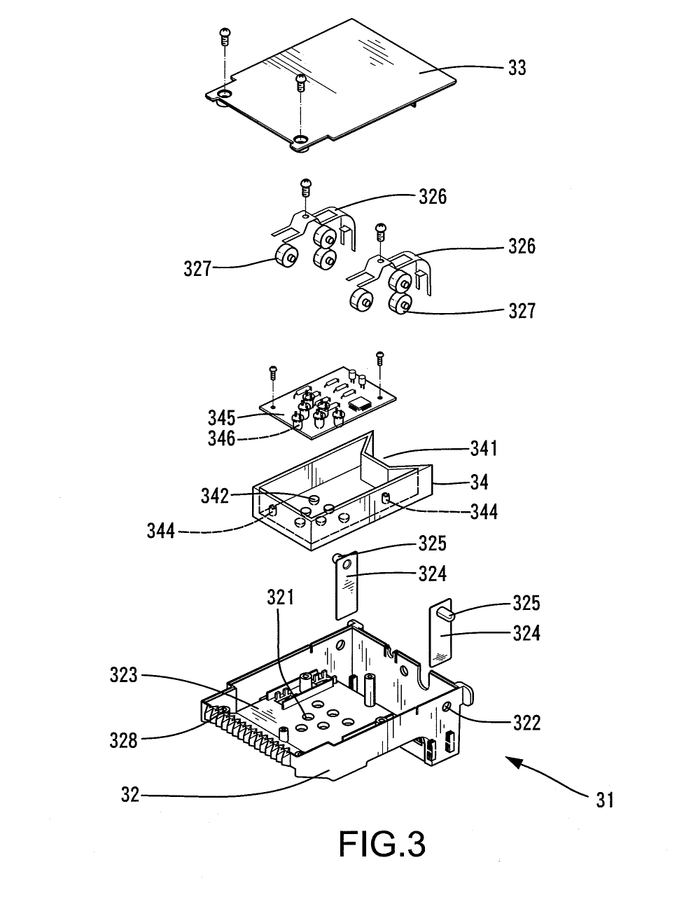

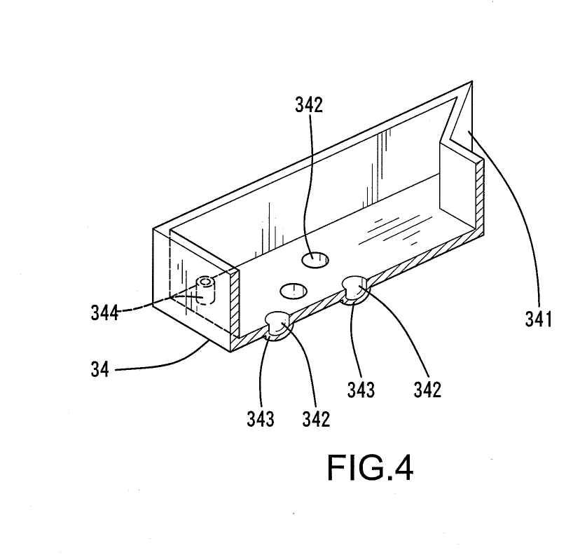

Referring to FIGS. 3 and 4, the upper sensor box 31 includes an L-shaped body 32, two locking units, a protective element 34, a control board 345, two roller units and a cover 33. The body 32 includes windows 321 defined therein, two apertures 322 defined therein and pegs 328 formed thereon.

Each of the locking units includes an elastic leaf 324 and a latch 325 transversely extended from the elastic leaf 324. The elastic leaves 324 are inserted in the body 32 while the latches 325 are inserted through the apertures 322.

Each of the roller units includes a leaf spring 326 for supporting three rollers 327. Each of the rollers 327 includes a portion disposed in the body 32 and another portion located out of the body 32 through apertures defined in the body 32.

The protective element 34 is made of a transparent material. The protective element 34 is in the form of a case with a periphery raised from a plate. The periphery of the protective element 34 includes a concave portion 341. Bubbles 343 are formed on the plate of the protective element 34 so that each of the bubbles 343 includes a cavity 342 in communication with a space defined in the protective element 34. Pegs 344 are formed on the plate of the protective element 34.

The control board 345 includes sensors 346 provided thereon. The sensors 346 are inserted in the bubbles 343. The bubbles 343 are inserted through the windows 321. Screws are driven into the pegs 344 through the control board 345 to secure the control board 345 to the protective element 34. Screws are driven into the pegs 328 through the cover 33 to secure the cover 33 to the body 32.

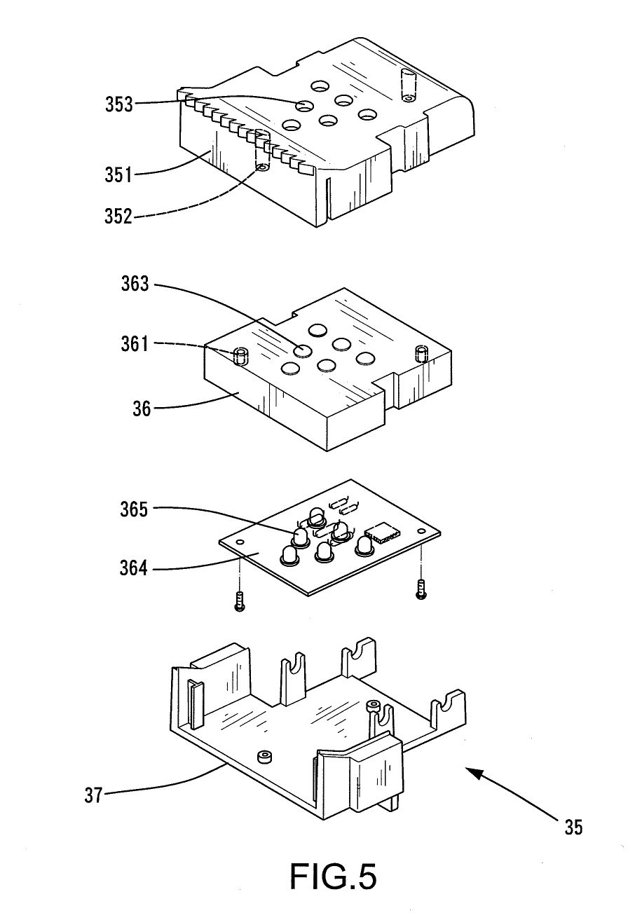

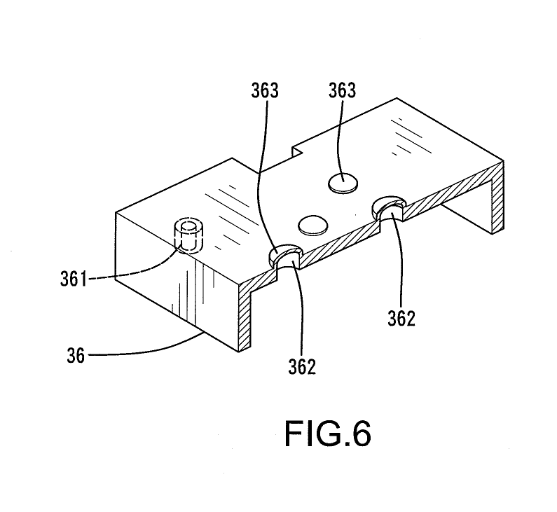

Referring to FIGS. 5 and 6, the lower sensor box 35 includes a body 351, a protective element 36, a control board 364 and a cover 37. The body 351 includes pegs 352 formed on a lower side and windows 353 defined therein.

The protective element 36 is made of a transparent material. The protective element 36 includes a periphery formed on a lower side of a plate. Pegs 361 are formed on the plate of the protective element 34. Bubbles 363 are formed on the plate of the protective element 36 so that each of the bubbles 363 includes a cavity 362 in communication with a space defined in the protective element 36.

The control board 364 includes sensors 365 provided thereon. The sensors 365 are inserted in the bubbles 363. The bubbles 363 are inserted through the windows 353. Screws are driven into the pegs 361 through the control board 364 to secure the control board 364 to the protective element 36. Screws are driven into the pegs 352 through the cover 37 to secure the cover 37 to the body 351.

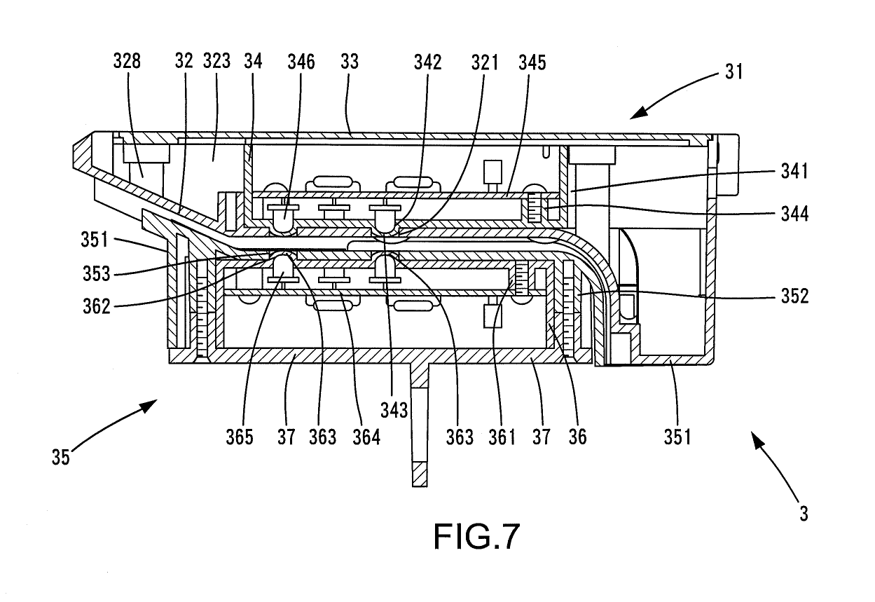

Referring to FIG. 7, the sensors 346 and 365 are disposed in the bubbles 343 and 363 while the bubbles 343 and 363 are disposed in the windows 321 and 353. Each of the bubbles 343 and 363 completely encloses a related one of the sensors 346 and 365. Moreover, each of the protective elements 34 and 36 covers an entire side of a related one of the control boards 345 and 364. The control boards 345 and 364 are firmly located against the protective elements 34 and 36 due to the screws driven in the pegs 344 and 361. Therefore, the control boards 345 and 364 are firmly protected from vapor. Short circuit or damage of the control boards 345 and 364 is avoided.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A bill-receiving apparatus comprising:
a shell;
a front cover attached to a front side of the shell, with the front cover including a slot through which a bill is insertable into the shell;
a bill-feeding mechanism for feeding the bill, with the bill-feeding mechanism comprising two pulley-belt modules each mounted on a side of the shell; and
a sensor assembly comprising an upper sensor box and a lower sensor box, with each of the upper and lower sensor boxes comprising:
a control board comprising at least one sensor mounted thereon;
a protective element comprising at least one bubble enclosing said at least one sensor; and
a body comprising at least one window in which said at least one bubble is disposed.

2. The bill-receiving apparatus according to claim 1, with the protective elements made of a transparent material and having U-shaped cross sections.

3. The bill-receiving apparatus according to claim 1, with each of the protective elements including at least one peg formed on a side thereof, and with each of the control boards secured to said at least peg of one of the protective elements.

4. The bill-receiving apparatus according to claim 1, with said at least one sensor of the control board of the upper sensor box including a plurality of sensors, and with said at least one bubble of the protective element of the upper sensor box including a plurality of bubbles each having a cavity, with each of the plurality of the sensors of the control board of the upper sensor box disposed in the cavity of one of the plurality of bubbles of the protective element of the upper sensor box.

5. The bill-receiving apparatus according to claim 4, with said at least one sensor of the control board of the lower sensor box including a plurality of sensors, with said at least one bubble of the protective element of the lower sensor box including a plurality of bubbles each having a cavity, with each of the plurality of sensors of the control board of the lower sensor box disposed in the cavity of one of the plurality of bubbles of the protective element of the lower sensor box.

6. The bill-receiving apparatus according to claim 1, with said at least one sensor of the control board of the lower sensor box including a plurality of sensors, with said at least one bubble of the protective element of the lower sensor box including a plurality of bubbles each having a cavity, with each of the plurality of sensors of the control board of the lower sensor box disposed in the cavity of one of the plurality of bubbles of the protective element of the lower sensor box.
